(19) United States
(12) Patent Application Publication
(10) Pub. No.: US 2019/0207928 A1
(43) Pub. Date: Jul. 4, 2019

(54) LOW-OVERHEAD SINGLE SIGN ON

(71) Applicant: JumpCloud, Inc., Boulder, CO (US)

(72) Inventors: Rajat Bhargava, Boulder, CO (US); Christopher Marie, Broomfield, CO (US); James Brown, Boulder, CO (US)

(21) Appl. No.: 16/298,941

(22) Filed: Mar. 11, 2019

Related U.S. Application Data
(63) Continuation-in-part of application No. 15/654,434, filed on Jul. 19, 2017, now abandoned.

(51) Int. Cl. H04L 29/06; H04L 12/24

(52) U.S. Cl. CPC H04L 63/0815; H04L 63/102; H04L 41/046

(57) ABSTRACT

Methods, systems, and devices for low overhead single sign on for user authentication are described. An endpoint agent may facilitate user authentication for access to third-party websites by receiving a request for authentication from a browser application and transmitting a request for an identity assertion to a central server. The central server may generate an identity assertion based on user attributes stored in a database for user information and may transmit the identity assertion to the endpoint agent. The endpoint agent may transmit the identity assertion to the browser application, where the browser application may then grant access to the user to the third-party website.

### CROSS REFERENCES

The present Application for Patent is a continuation-in-part of U.S. patent application Ser. No. 15/654,434 by Bhargava et al., entitled “Low-Overhead Single Sign On,” filed Jul. 19, 2017, which is assigned to the assignee hereof and expressly incorporated by reference herein.

### BACKGROUND

Many websites and applications request some form of authorization in order for a user to gain access to their content. A popular authorization mechanism is for a user identity to be authenticated, where a user typically provides a username and password. If the username and password are recognized by a website or application, the user is granted access to that website's or application's content. However, as each website or application may require their own user identity authentication, the time that a user needs to gain access to these websites and applications increases with each website and application a user needs to gain access to.

Many attempts have been made to reduce the number of times a user needs to authenticate their identity. Some solutions have included having a central identity for Hypertext Transfer Protocol (HTTP)-based authentication and exchange of information via the HTTP. However, this solution requires authenticating once into a machine and then subsequently into a central identity provider. Other solutions can propagate a user identity from the machine itself, but only if that machine is attached to a particular domain and the service provider is also attached to that domain. Techniques for providing a user identity across multiple protocols and without a direct association with a service provider may thus decrease overhead associated with user authentication.

### SUMMARY

Methods, systems, and devices that support low overhead single sign on for users are described. Within a networked, cloud-based computing system, an endpoint agent may facilitate identity authentication for users of the computing system. The endpoint agent, which may also be referred to as an agent, may receive requests for an identity assertion of a user from a browser application, and the endpoint agent may send the request to a server capable of generating the identity assertion. Furthermore, the identity assertion may be generated based on stored user attributes. The endpoint agent may send a generated identity assertion to the browser application, which may then use the assertion for asserting the user's identity to a third-party website.

A method for user authentication within a networked computer system is described. The method may include receiving at an endpoint agent from a browser application a request for authentication information that identifies a user of an endpoint device for access to a third-party website that requires authentication of the user, transmitting from the endpoint agent to a server a request for an identity assertion for the user, receiving at the endpoint agent from the server the identity assertion for the user in response to the request for the identity assertion, and transmitting from the endpoint agent to the browser application the identity assertion for asserting the user's identity to the third-party website.

A system for user authentication is also described. The system may include a server that is operable to generate an identity assertion for a user requesting access to a third-party website that requires authentication of the user, a browser application that is operable to provide access to the third-party website, and an endpoint agent in electronic communication with the server and the browser application, wherein the endpoint agent is operable to generate a request for the identity assertion for the server to communicate the identity assertion from the server to the browser application.

A non-transitory computer-readable medium storing code for authenticating a user is also described. The code may include instructions executable to receive from a browser application a request for authentication that identifies a user of an endpoint device for access to a third-party website that requires authentication of the user, transmit to a server a request for an identity assertion for the user; receive from the server the identity assertion for the user in response to the request for the identity assertion, and transmit to the browser application the identity assertion for asserting the user's identity to the third-party website.

Some examples of the method, system, or non-transitory computer-readable medium described herein may further include processes, features, means, or instructions for generating the identity assertion at the server in response to the request for the identity assertion from the endpoint agent based at least in part on one or more user attributes stored in a database of user information. Additionally or alternatively, the identity assertion may be generated based at least in part on referencing the database of user information. Additionally, in some examples the identity assertion may be in a format used by the third-party website.

Some examples of the method, system, or non-transitory computer-readable medium described herein may further comprise a browser plug-in, wherein the transmitting from the endpoint agent to the browser application the identity assertion comprises transmitting to the browser plug-in the identity assertion for asserting the user's identity to the third-party website, and authenticating at the browser plug-in the identity assertion. Additionally or alternatively, in some examples the request for authentication information that identifies the user is received from and initiated by the browser plug-in.

Some examples of the method, system, or non-transitory computer-readable medium described herein may further include processes, features, means, or instructions for receiving login credentials of the user from an operating system, wherein the request for the identity assertion for the user is based at least in part on the received login credentials. Additionally, in some examples the login credentials may be received while a device that hosts the endpoint agent is disconnected from communication with the server, and wherein the request for the identity assertion is transmitted when the device that hosts the endpoint agent regains a communication connection with the server.

Some examples of the method, system, or non-transitory computer-readable medium described herein may further include processes, features, means, or instructions for establishing a communication session with the third-party website using the browser application, wherein the establishment is based at least in part on the identity assertion. Additionally, some examples may include establishing a second communication session with a second third-party website using the browser application, wherein the establishment is based at least in part on the identity assertion.

Some examples of the method, system, or non-transitory computer-readable medium described herein may further include processes, features, means, or instructions for terminating a communication session with the third-party website using the browser application, wherein the termination is based at least in part on a revocation of the identity assertion from the endpoint agent. Additionally, some examples may include receiving at the endpoint agent from the server a command to revoke the identity assertion, wherein the command to revoke is based at least in part on input from a system administrator or the user received at the server.

### BRIEF DESCRIPTION OF THE DRAWINGS

Aspects of the disclosure are described with reference to the following figures:

FIG. 1 illustrates an exemplary system that supports low-overhead single sign on for user authentication in accordance with various aspects of the present disclosure;

FIG. 2 illustrates an example of a user perspective for low-overhead single sign on for user authentication in accordance with various aspects of the present disclosure;

FIG. 3 illustrates an example of a device that supports low-overhead single sign on for user authentication in accordance with various aspects of the present disclosure;

FIG. 4 illustrates an example of a central server that supports low-overhead single sign on for user authentication in accordance with various aspects of the present disclosure;

FIG. 5 illustrates an exemplary process flow in a system that supports low-overhead single sign on for user authentication in accordance with various aspects of the present disclosure;

FIGS. 6-8 illustrate methods for low overhead single sign on for user authentication in accordance with various aspects of the present disclosure.

### DETAILED DESCRIPTION

An endpoint agent, which may also be referred to as an “agent,” coupled to a central server may allow for users to be authenticated for access to third-party websites without the need for multiple user sign on attempts. For instance, usernames and passwords associated with a user may be stored in a central server. The endpoint agent may be configured so that the endpoint agent may assert the identity of the user into a browser session directly, without the need for users to re-login into a second protocol. This identity assertion may be generated by the central server which houses credentials of a user, such as the user's username and password. The endpoint agent may thus reduce overhead associated with signing on to third-party websites.

Additionally, the endpoint agent may allow for seamless integration between the identity on a device and the identity asserted to service providers. Unlike other identity assertion methods, the system for authenticating users described herein may provide for generating and transmitting a user identity assertion that is independent of both the location of the user as well as the service provider involved.

Aspects of the disclosure are initially described below in the context of a system that supports low-overhead single sign on for user authentication. Various examples of low overhead single sign on, a server, and a central server are then described. These and other aspects of the disclosure are further illustrated by and described with reference to apparatus diagrams, system diagrams, and flowcharts that relate to low-overhead single sign on for user authentication.

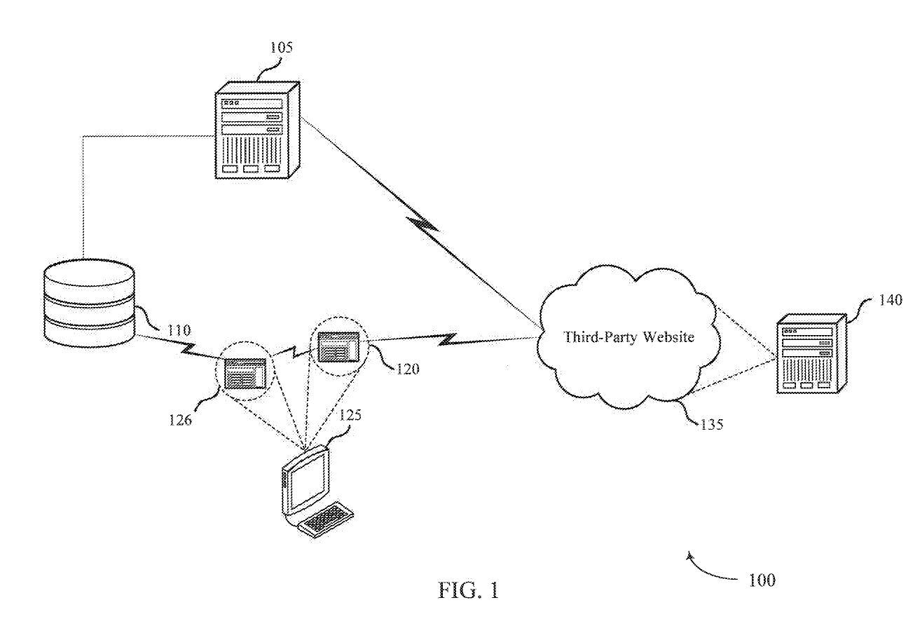

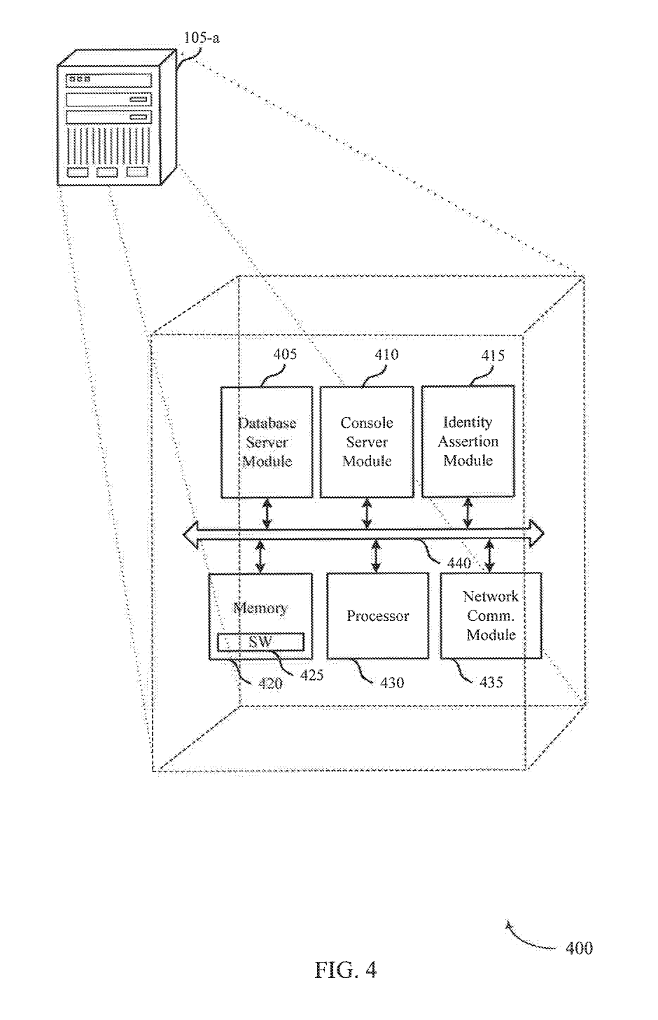

FIG. 1 illustrates an exemplary system 100 that supports low overhead single sign on for user authentication in accordance with various aspects of the present disclosure. The system 100 includes a central server 105. The central server 105 may include a database of user information 110, which may store user attributes such as a username and password. Alternatively, the database of user information 110 may be housed separately from the central server 105. Additionally or alternatively, the central server 105 may house backend, low overhead single sign on (SSO) code for generating an identity assertion of a user. An example of the central server 105 is described in more detail with reference to FIG. 4.

The central server 105 may also communicate with an endpoint device 125 via a browser application 120. The browser application 120 may be a software application for retrieving and presenting information resources on the World Wide Web and may be hosted on or an aspect of the device 125, which may also be referred to as a user terminal. The browser application may be able to operate across various protocols, such as hypertext transfer protocol (HTTP), and various operating systems.

Endpoint device 125 may provide a user with access to system 100. Device 125 may include computing devices of various types (e.g., mobile phones, tablets, notebook computers, desktop computers, servers, etc.), which may utilize various operating systems. Device 125 may include an endpoint agent 126 to facilitate user authentication for access to websites and content. A user may operate device 125 in an attempt to access a third-party website 135 via browser application 120. Third-party website 135 may be managed or hosted by server 140. While proceeding examples discuss access to third-party websites, the system 100 may additionally or alternatively grant access to various third-party applications and content.

The third-party website 135 may require user authentication before granting access to its content to the device 125. However, rather than the browser application 120 transmitting a request for user authentication generated by the third-party website 135 to the endpoint device 125 for manual input by a user, the browser application 120 may transmit the request for user authentication to the endpoint agent 126 stored in user device 125. The endpoint agent 126 may transmit a request for identity assertion to central server 105, which may subsequently generate the identity assertion for the user based on attributes for the user stored in the database of user information 110. Stored attributes may include a username, a password, a certificate-based key, or any other attribute or credential associated with a user. Additionally or alternatively, the central server 105 may generate the identity assertion based on login credentials received from an operating system. Further, these stored attributes may be updated by a user via input received by the endpoint device 125, and these updates may subsequently be transmitted to central server 105 and database of user information 110. In some examples, the endpoint agent 126 may request the user authentication information from the central server 105. In this example, the endpoint agent 126 may not transform the login authorization information itself, but may instead request the user authentication information from the central server 105. Once the endpoint agent 126 receives the user authentication information from the central server 105, the endpoint agent 126 may respond to the third-party website 135.

The central server 105 may generate an identity assertion based on the attributes stored in the database of user information 110. The central server 105 may determine what information to provide in the identity assertion based on information included in the request for the identity assertion. The generated identity assertion may be transmitted to the endpoint agent 126, which may subsequently transmit the generated identity assertion to the browser application 120 for authenticating the user. Once the generated identity assertion is validated, the third-party website 135 may grant access to the device 125 to the contents of the website. Thus, once the user gains access to the device 125, authentication methods for receiving access to various third-party websites are managed without additional user input, which may reduce overhead (e.g., signaling latency, number of signals exchange, user time, processing time, server calls, etc.) associated with gaining access to third-party websites.

In some examples, the endpoint agent 126 may receive a request for authentication information from the browser application 120. The authentication information may allow a user of the endpoint device 125 access to the third-party website 135 or application. The authentication information may be in an authentication format specific to the third-party website or application, such as a format that is required by the third-party website 135 or application. Different third-party websites or applications may require authentication credentials in different authentication formats, and the endpoint agent 126 may transform or reformat stored authentication credentials for the user into the specific authentication format required by a specific third-party website or application in a way that is seamless and invisible to the user.

Some examples of authentication formats that may be used or required by third-party websites or applications may include basic authentication, proprietary authentication, externally verified authentication, and passwordless authentication. Basic authentication may include the authentication formats, basic authentication with secure sockets layer (SSL), and Digest Authorization. Basic authentication may be a form of secure “assertion” and may be employed to assure that a website or application is accessed and also to verify that the absence of a “middle man” that may attack the website or application or the user. Propriety authentication may include third-party form-based authentication built into a third-party website or application (e.g., using a user name and a password or other credentials). Externally verified authentication may include, for example, authentication based on one or more of: Open Authorization 2 (OAuth2), security assertion markup language (SAML2), OpenID, lightweight directory access protocol (LDAP), or Kerberos. OAuth2 may employ true secure assertion into a website or application using some form of identity. In some examples, OAuth2 may be employed without using form-based authentication, and may leverage an already-verified/external identity (e.g. a username and password from another login) as the key to gain access to the web-application. In some examples, SAML2, OpenID, and LDAP may operate similarly to OAuth2. Kerberos, may employ an identity store and may be designed to provide access to web-based content typically within a domain (e.g., less across the open internet). Kerberos may rely on non-form based authentication schemes to verify identification and authorize access. Passwordless authentication may use, for example, the Fast ID Online Web Authentication (FIDO WebAuthn) Standard.

In some examples, a user may log into any endpoint device and accordingly may log into the installed endpoint agent. The endpoint agent may manage the identity assertion information and may assert the identity of the user, to any third-party website or application in an authentication format specific to or required by the third-party website or application, after the user has logged into the endpoint agent. In this example, the endpoint agent may manage the identity assertion without the user having to log in to the third-party website or application via the browser. In turn, when using the endpoint device with the endpoint agent, the browser and the operating system may operate somewhat independently of one another with respect to authentication information, and may not be coupled together to provide identity assertion information to the third-party website or application. That is, when accessing a third-party website or application, the identity assertion information may not be dependent on the user logging into the device and then separately logging into the third-party website or application by entering identity assertion information into the browser.

Additionally, the device 125 may initiate a communication link with the third-party website 135 after receiving access. At this point, the device 125 may have access to the content held on the third-party website 135. In some examples, the user may wish to access another third-party website. This second third-party website may require authentication credentials separate from the third-party website 135. In this case, the browser application 120 may use the identity assertion previously generated to validate the user and subsequently grant access to the second third-party website. This reuse of the identity assertion may further reduce overhead, such as latency or user time, associated with multiple sign on procedures by removing the need for the creation of a second identity assertion. In this case, the browser application 120 may store the identity assertion for the user for future third-party authentication requests. Alternatively, instead of storing the identity assertion, the browser application 120 may instead transmit a request for user authentication to the endpoint agent 126 and subsequently receive a second generated identity assertion for the user.

Additionally or alternatively, browser application 120 may include a browser plug-in. The browser plug-in may be a software component that authorizes identity assertions received by the browser application 120. The browser plug-in may alternatively be a browser extension or any similar application known by those skilled in the art. The browser plug-in may perform the functions of the browser application 120 as described above.

The various elements of system 100, or the devices, components, and elements of system 100 may be coupled to one another and/or may be in electronic communication with one another. As used herein, “in electronic communication” means a relationship between components that facilitates an exchange of information, signals, waveforms, electrons, and the like.

Additionally, aspects of system 100 may be accessible by and managed through a web-based console. The console may include or be a user interface that provides access to the database of user information 110 hosted on central server 105. The console may provide remote access to the central server 105 via an Internet connection and, for instance, a wireless access point. Those skilled in the art will recognize, however, that because central server 105 may be a cloud server, remote access to central server 105 may be achieved in a variety of ways. The console may be or employ a representational state transfer (REST) application programmer interface (API). The REST API may be used to search or query the database of user information S110. Additionally or alternatively, the REST API may be used to modify the user attributes stored in the database of user information 110. Additionally or alternatively, the REST API may be used to revoke an identity assertion, where a system administrator or user provides a command to revoke via the REST API to the central server 105. This identity assertion revocation may be used by the central server 105 to terminate an existing communication link with the device 125 and a third-party website, to revoke future attempts by device 125 to gain access to a third-party website, or both.

The various elements, components, servers and devices of system 100 may be connected to one another wirelessly or with wired connections. In some cases, they are connected via the Internet. Communication between the various devices may utilize Transport Layer Security (TLS), Secure Sockets Layer (SSL), or some other security or encryption protocol. As used herein, the term server refers to a computer or program in a network that provides services, including access to applications, files, peripherals, etc., to other computers or programs, or consoles within a network. As discussed below, this may include both software and hardware, and real and virtual machines. In some examples, a server is a computer program that operates to support or perform tasks on behalf of other programs, computers, or users. Further, as used herein, a server may include a “rack” or enclosure housing computer hardware and software.

The system 100 may thus support low-overhead single sign on for user authentication. This may be accomplished, in part, with an endpoint agent hosted in a device, which may facilitate authentication and authorization for user access of third-party content across devices types, operating systems, and SaaS applications.

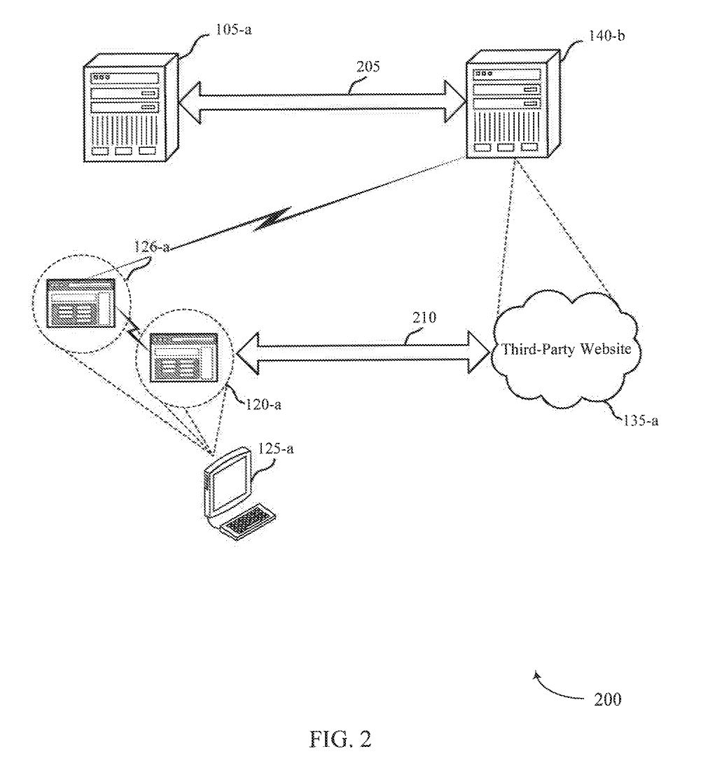

FIG. 2 depicts an example 200 of a user perspective for low-overhead single sign on for user authentication in a system, in accordance with various aspects of the present disclosure. Browser application 120-a may be an example of browser application 120 of system 100 and may be hosted on device 125-a, which may facilitate communication with server 105-a via endpoint agent 126-a. Sever 105-a and endpoint agent 126-a may be examples of server 105 and endpoint agent 126, as described with reference to FIG. 1. Additionally, third-party website 135-a may be an example of third-party website 135 of system 100 and may be hosted by server 140-a, which may be an example of server 140 of system 100. Browser application 120-a may provide content to a user via a device, such as device 125 of system 100. When a user attempts to gain access to the third-party website 135-a via the browser application 120-a, the user may receive access without receiving a request for authentication from the website 135-a. Thus, from the perspective of the user, the browser application 120-a may seamlessly communicate with the third-party website 135-a via communication link 210.

However, the request for authentication, and a subsequent user identity assertion, may be communicated between server 140-a, which may host the third-party website 135-a, and the server 115-a via communication link 205. In this way, authentication mechanisms that are in place to access the third-party website 135-a may still be met without the user participating in the authentication process.

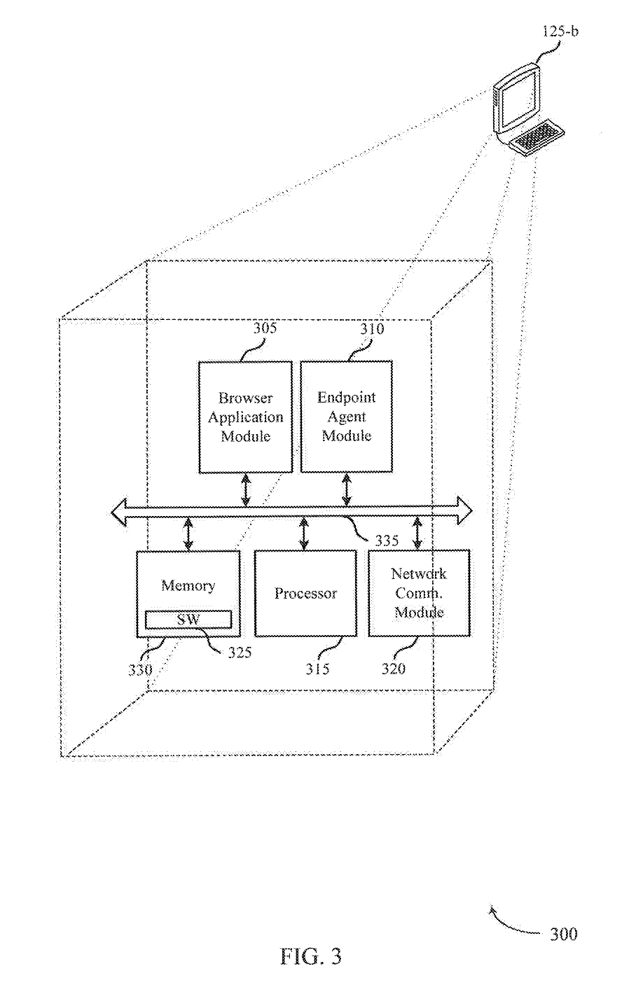

FIG. 3 illustrates an example 300 of a device 125-b that supports low-overhead single sign on for user authentication in accordance with various aspects of the present disclosure. The device 125-b may be an example of device 125 described with reference to FIGS. 1 and 2, and may include a browser application module 305 and an endpoint agent module 310.

The endpoint agent module 310 may be an example of the endpoint agent 126 of FIG. 1 and may facilitate user authentication in a system, such as system 100 of FIG. 1. Endpoint agent module 310 may be a hardware module or a software module, or a combination of hardware and software (e.g., a special-purpose processor). The endpoint agent module 310 may, in some cases and in combination with other components of the device 125-b, receive a request for authentication, transmit an identity assertion request to a server, receive an identity assertion for a user, and transmit the identity assertion to a browser application, as described with reference to FIGS. 1 and 2.

The browser application module 305 may facilitate communication with a browser application 120 (e.g., via a browser plug-in) and may, in combination with other components of the device 125-b, receive and transmit a request for authentication, receive an identity assertion, and validate an identity assertion, as described with reference to FIGS. 1 and 2.

The device 125-b may include a processor 315, memory 330 (including software/firmware (SW) 325), and a network communications module 320. The various modules of the device 125-b may be in communication via one or more buses 335. The network communications module 320 may be configured for secure, bi-directional communication with other devices, servers, and the like in a system, such as system 100 of FIG. 1, via one or more wired or wireless links. For example, the network communications module 320 may include a modem configured to modulate packets and transmit them to, and to demodulate received packets.

The memory 330 may include random access memory (RAM) and read only memory (ROM). The memory 330 may store computer-readable, computer-executable software/firmware code 325, including instructions that, when executed, cause the processor 315 to perform various functions described herein (e.g., facilitating low overhead single sign on.). Alternatively, the software/firmware code 325 may not be directly executable by the processor 315 but cause a computer (e.g., when compiled and executed) to perform functions described herein. The processor 315 may include an intelligent hardware device, (e.g., a central processing unit (CPU), a microcontroller, an ASIC, etc.).

FIG. 4 illustrates an example 400 of a central server 105-a that supports low overhead single sign on for user authentication in accordance with various aspects of the present disclosure. The central server 105-a may be an example of central server 105 with reference to FIG. 1, and may include a database server module 405, a console server module 410, and an identity assertion module 415.

The database server module 405 may be an example of the database of user information 110 of FIG. 1 and may host user attributes for generating identity assertions for a user as described with reference to FIG. 1.

The console server module 410 may, in combination with other components of the central server 105-a, identify a command received via a web-based console, as described with reference to FIG. 1.

The identity assertion module 415 may generate an identity assertion in response to receiving a request for an identity assertion as described with reference to FIG. 1. The identity assertion module 415 may reference a database that includes user information and authentication information.

The central server 105-a may include a processor 430, memory 420 (including software/firmware (SW) 425), and a network communications module 435. The various modules of the server 105-a may be in communication via one or more buses 440. The network communications module 435 may be configured for secure, bi-directional communication with other devices, servers, and the like in a system, such as system 100 of FIG. 1, via one or more wired or wireless links. For example, the network communications module 435 may include a modem configured to modulate packets and transmit them to, and to demodulate received packets.

The memory 420 may include random access memory (RAM) and read only memory (ROM). The memory 420 may store computer-readable, computer-executable software/firmware code 425, including instructions that, when executed, cause the processor 520 to perform various functions described herein (e.g., facilitating low overhead single sign on.). Alternatively, the software/firmware code 425 may not be directly executable by the processor 430 but cause a computer (e.g., when compiled and executed) to perform functions described herein. The processor 430 may include an intelligent hardware device, (e.g., a central processing unit (CPU), a microcontroller, an ASIC, etc.).

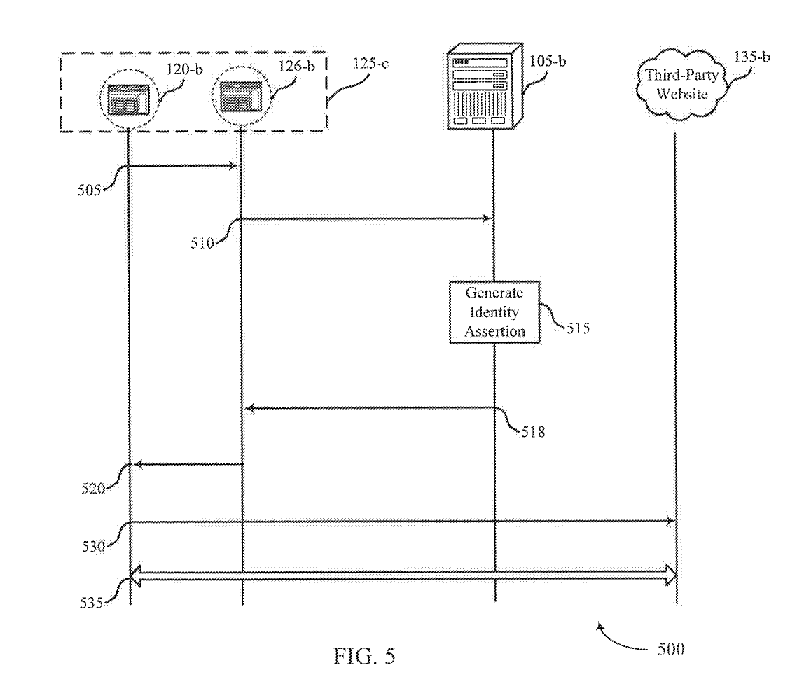

FIG. 5 illustrates an exemplary process flow in a system, such as system 100 of FIG. 1, that supports low overhead single sign one for user authentication in accordance with various aspects of the present disclosure. The process flow 500 may include a user device 125-c, browser application 120-b, endpoint agent 126-b, central server 105-b, and third-party website. Each of these may be examples of corresponding devices, entities, and the like, described with reference to FIGS. 1-4.

At 505, browser application 120-b, hosted at device 125-c, may transmit a request to authenticate a user to an endpoint agent 126-b hosted at device 125-c. The endpoint agent 126-b may be an endpoint agent 126 as described with reference to FIGS. 1-3. At 510, the endpoint 126-b agent may transmit a request for identity assertion to a central server 105-b. The central server 105-b may be as described with reference to FIGS. 1 and 4. Additionally or alternatively, the request for identity assertion may be based on login credentials of the user received from an operating system. In some cases, the login credentials are received while the device 125-c is disconnected from communication with the central server 105-b, where the request for identity assertion is transmitted when the device 125-c regains communication connection with the central server 105-b.

At 515, the central server 105-b may generate the identity assertion. In some instances, the identity assertion may be generated in response to the request for the identity assertion. Additionally or alternatively, the identity assertion for the user is in a format used by a third-party website. Additionally or alternatively, the identity assertion may be generated based at least in part on one or more attributes stored in a database of user information as described with reference to FIG. 1.

At 518, the central server 105-b may transmit the identity assertion to the endpoint agent 126-b. The identity assertion may be a data packet or other information indicative of a user's identity. At 520, endpoint agent 126-b may provide the identity assertion to endpoint agent 126-b. The browser application 120-b may include a browser plug-in, where the browser plug-in may receive and validate the identity assertion.

At 530, the browser application 120-b may assert the user's identity to a third-party website 135-b. The browser application 120-b may parse data or information received from the endpoint agent 126-b to assert the user's identity. In some cases, the endpoint agent 126-b may receive a command to revoke the identity assertion, which the endpoint agent 126-b may communicate to the browser application 120-b, and the browser application 120-b may, in turn revoke the identity assertion and terminate authenticated communications with the third-party website 135-b.

At 535, the device 125-c may initiate a communication link with the third-party website 135-b via the browser application 120-b. The communication link may be initiated based at least in part on the device 125-c being granted access to the third-party website 135-b by the browser application 120-b. A communication link may be terminated by the browser application 120-b based on revocation of the identity assertion.

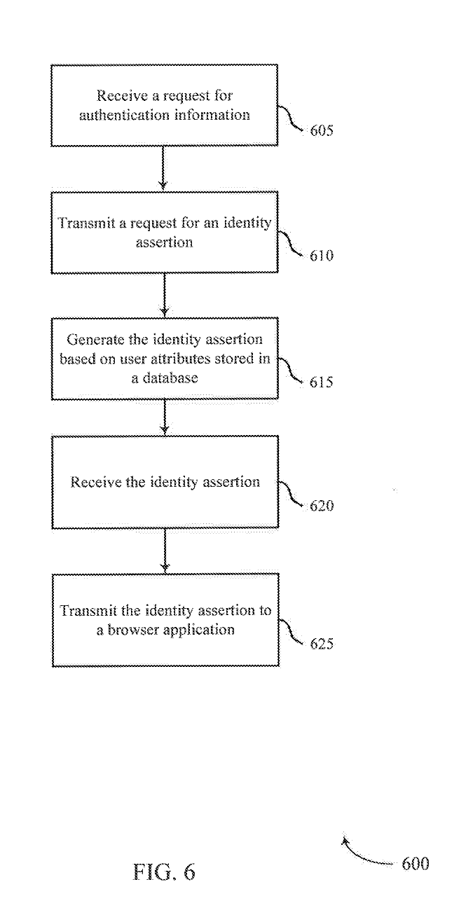

FIG. 6 illustrates a method 600 for low overhead single sign on for user authentication in accordance with various aspects of the present disclosure. The operations of method 600 may be implemented by various servers and devices within a system, as described with reference to FIGS. 1-5. In some examples, one or more servers, such as central server 105, may execute a set of codes to control the functional elements of servers and devices with the system 100 to perform the functions described below. Additionally or alternatively, the central server 105 may perform aspects of the functions described below using special-purpose hardware.

At block 605, an endpoint agent may receive a request for authentication from a browser application. The endpoint agent may be as described with reference to FIGS. 1-3 and may be stored in a device. At block 610, the endpoint agent may transmit a request for identity assertion to the central server. The central server may be as described with reference to FIGS. 1 and 4. In certain examples, the operations of blocks 605 and 610 may be performed by the endpoint agent module 310 as described with reference to FIG. 3.

At block 615, the central server may generate the identity assertion. In some instances, the identity assertion may be generated in response to the request for the identity assertion. Additionally or alternatively, the identity assertion may be generated based at least in part on one or more attributes stored in a database of user information. Additionally or alternatively, the identity assertion is in a format used by a third-party website. In certain examples, the operations of block 615 may be performed by the identity assertion module 415 as described with reference to FIG. 4.

At block 620, the central server may transmit the identity assertion to the endpoint agent. In certain examples, the operations of block 620 may be performed by the network communications module 435 as described with reference to FIG. 4. At block 625 the endpoint agent may transmit the identity assertion to the browser application. In some instances, the browser application may validate the identity assertion. Additionally, the browser application may include a browser plug-in, where the browser plug-in receives and validates the identity assertion. In certain examples, the operations of block 625 may be performed by the network communications module 320 as described with reference to FIG. 3.

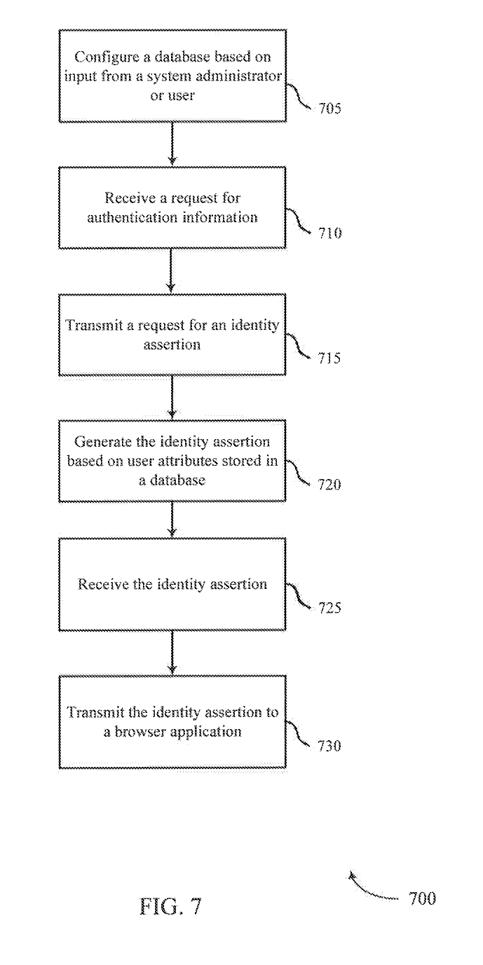

FIG. 7 illustrates a method 700 for low overhead single sign on for user authentication in accordance with various aspects of the present disclosure. The operations of method 700 may be implemented by various servers and devices within a system, as described with reference to FIGS. 1-5. In some examples, one or more servers, such as central server 105, may execute a set of codes to control the functional elements of servers and devices with the system 100 to perform the functions described below. Additionally or alternatively, the central server 105 may perform aspects the functions described below using special-purpose hardware.

At block 705, a database of user information may be configured by a system administrator or a user. In certain examples, the database of user information may be configured by providing user identity information for associated users. In certain examples, the operations of block 705 may be performed by the database server module as described with reference to FIG. 4.

At block 710, an endpoint agent may receive a request for authentication from browser application. The endpoint agent may be described with reference to FIG. 1 and may be stored in a device. At block 715, the endpoint agent may transmit a request for identity assertion to the central server. The central server may be as described with reference to FIG. 4. In certain examples, the operations of blocks 710 and 715 may be performed by the endpoint agent module 310 as described with reference to FIG. 3.

At block 720, the central server may generate the identity assertion, where the identity assertion may be generated based at least in part on one or more attributes stored in a database of user information. In some instances, the identity assertion may be generated in response to the request for the identity assertion. Additionally or alternatively, the identity assertion is in a format used by a third-party website. In certain examples, the operations of block 720 may be performed by the identity assertion module 415 as described with reference to FIG. 4.

At block 725, the central server may transmit the identity assertion to the endpoint agent. In certain examples, the operations of block 725 may be performed by the network communications module 435 as described with reference to FIG. 4. At block 730 the endpoint agent may transmit the identity assertion to the browser application. In some instances, the browser application may validate the identity assertion. Alternatively, the browser application may not recognize the identity assertion and thus may revoke the identity assertion received. The browser application may include a browser plug-in, where the browser plug-in receives and validates the identity assertion. In certain examples, the operations of block 730 may be performed by the network communications module 320 as described with reference to FIG. 3.

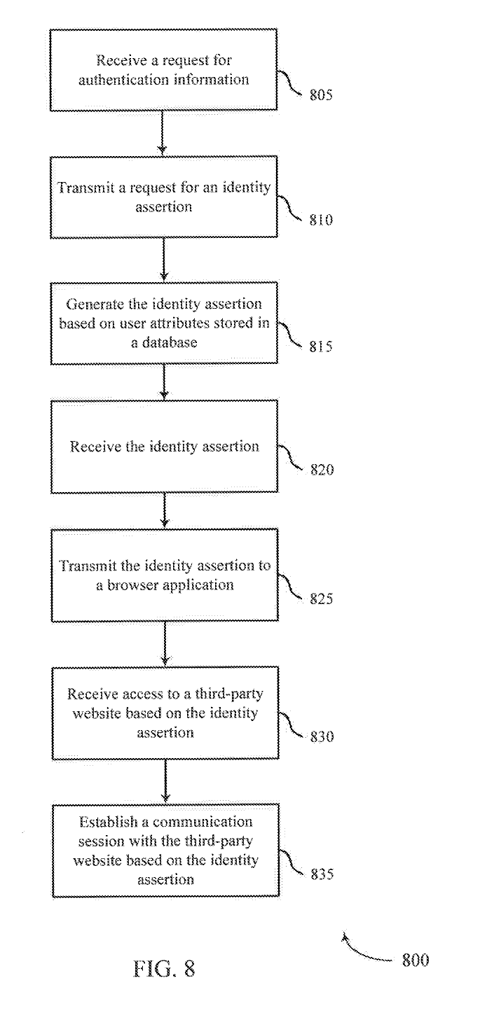

FIG. 8 illustrates a method 800 for low overhead single sign on for user authentication in accordance with various aspects of the present disclosure. The operations of method 800 may be implemented by various servers and devices within a system, as described with reference to FIGS. 1-5. In some examples, one or more servers, such as central server 105, may execute a set of codes to control the functional elements of servers and devices with the system 100 to perform the functions described below. Additionally or alternatively, the central server 105 may perform aspects the functions described below using special-purpose hardware.

At block 805, endpoint agent may receive a request for authentication from browser application. The endpoint agent may be described with reference to FIG. 1 and may be stored in a device. At block 810, the endpoint agent may transmit a request for identity assertion to the central server. The central server may be as described with reference to FIG. 4. In certain examples, the operations of blocks 805 and 810 may be performed by the endpoint agent module 310 as described with reference to FIG. 3.

At block 815, the central server may generate the identity assertion, where the identity assertion may be generated based at least in part on one or more attributes stored in a database of user information. In some instances, the identity assertion may be generated in response to the request for the identity assertion. Additionally or alternatively, the identity assertion is in a format used by a third-party website the user is attempting to sign on to. In certain examples, the operations of block 815 may be performed by the identity assertion module 415 as described with reference to FIG. 4.

At block 820, the central server may transmit the identity assertion to the endpoint agent. In certain examples, the operations of block 820 may be performed by the network communications module 435 as described with reference to FIG. 4. At block 825 the endpoint agent may transmit the identity assertion to the browser application. In some instances, the browser application may validate the identity assertion. In certain examples, the operations of block 825 may be performed by the network communications module 320 as described with reference to FIG. 3.

At block 830, a device may receive access to the third-party website based at least in part on the identity assertion. The device may house the endpoint agent. Access to the third-party website may be granted by the browser application. In certain examples, the operations of block 830 may be performed by the browser application module as describe in reference to FIG. 3.

At block 835, the device may establish a communication link with the third-party website based at least in part on the identity assertion. In certain examples, the operations of block 835 may be performed by browser application module, or alternatively, network communications module 320 as described with reference to FIG. 3.

Thus, methods 600, 700, and 800 may provide low-overhead single sign on for user authentication. It should be noted that methods 600, 700, and 800 describe possible implementations, and that the operations and the steps may be rearranged or otherwise modified such that other implementations are possible. In some examples, aspects from two or more of the methods 600, 700, and 800 may be combined.

The description herein provides examples, and is not limiting of the scope, applicability, or examples set forth in the claims. Changes may be made in the function and arrangement of elements discussed without departing from the scope of the disclosure. Various examples may omit, substitute, or add various procedures or components as appropriate. Also, features described with respect to some examples may be combined in other examples.

The description set forth herein, in connection with the appended drawings, describes example configurations and does not represent all the examples that may be implemented or that are within the scope of the claims. The term “exemplary” as may be used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and devices are shown in block diagram form in order to avoid obscuring the concepts of the described examples.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

Information and signals described herein may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a DSP, an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a digital signal processor (DSP) and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations. Also, as used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C).

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media can comprise RAM, ROM, electrically erasable programmable read only memory (EEPROM), compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not to be limited to the examples and designs described herein but is to be accorded the broadest scope consistent with the principles and novel features disclosed herein.

What is claimed is:

1. A method for user authentication within a networked computer system, comprising:
receiving login credentials at an endpoint device for a user to gain access to the endpoint device;
receiving at an endpoint agent on the endpoint device and from a browser application a request for authentication information that identifies the user of the endpoint device for access to a third-party website that requires authentication of the user in an authentication format specific to the third-party website;
transmitting from the endpoint agent to a server a request for an identity assertion for the user, wherein the request for the identity assertion for the user is based at least in part on the received login credentials;
receiving at the endpoint agent from the server the identity assertion for the user in response to the request for the identity assertion; and
transmitting from the endpoint agent to the browser application the identity assertion for asserting an identity of the user to the third-party website.

2. The method of claim 1, further comprising:
generating the identity assertion at the server in response to the request for the identity assertion from the endpoint agent based at least in part on one or more user attributes stored in a database of user information.

3. The method of claim 2, further comprising:
configuring the database of user information based at least in part on input from a system administrator or the user, or both.

4. The method of claim 1, wherein the browser application comprises a browser plug-in, and wherein transmitting from the endpoint agent to the browser application the identity assertion comprises:
transmitting to the browser plugin the identity assertion for asserting the user's identity to the third-party website; and
authenticating at the browser plug-in the identity assertion.

5. The method of claim 1, further comprising:
receiving access by the browser application to the third-party website based at least in part on the identity assertion.

6. The method of claim 1, wherein the login credentials are received while a device that hosts the endpoint agent is disconnected from communication with the server, and wherein the request for the identity assertion is transmitted when the device that hosts the endpoint agent regains a communication connection with the server.

7. The method of claim 1, wherein the identity assertion for the user is in a format used by the third-party website.

8. The method of claim 1, wherein the request for authentication information that identifies the user is received from and initiated by a plug-in of the browser application.

9. The method of claim 1, further comprising:
establishing a communication session with the third-party website using the browser application, wherein the establishment is based at least in part on the identity assertion.

10. The method of claim 9, further comprising:
establishing a second communication session with a second third-party website using the browser application, wherein the establishment is based at least in part on the identity assertion.

11. The method of claim 1, further comprising:
terminating a communication session with the third-party website using the browser application, wherein the termination is based at least in part on a revocation of the identity assertion from the endpoint agent.

12. The method of claim 1, further comprising:
receiving at the endpoint agent from the server a command to revoke the identity assertion, wherein the command to revoke is based at least in part on input from a system administrator or the user received at the server.

13. A system for user authentication, comprising:
a hardware-implemented server that is operable to generate an identity assertion for a user requesting access to a third-party website that requires authentication of the user in an authentication format specific to the third-party website;
a hardware-implemented user device operable to receive login credentials for the user to gain access to the user device, the user device comprising a browser application that is operable to provide access to the third-party website and an endpoint agent in communication with the server and the browser application, wherein the endpoint agent is operable to generate a request for the identity assertion for the server to communicate the identity assertion from the server to the browser application, wherein the request for identity assertion is based at least in part on the received login credentials.

14. The system of claim 13, wherein the server is operable to generate the identity assertion based at least in part on referencing a database of user information, and wherein the server comprises:
the database of user information; and
an identify assertion module that is operable to reference the database of user information.

15. The system of claim 14, wherein the server is operable to configure the database of user information based at least in part on input from a system administrator or the user, or both.

16. The system of claim 13, wherein the browser application comprises:
a browser plugin that is operable to authenticate the identity assertion from the server.

17. The system of claim 13, wherein the browser application is operable to provide access to the third-party website based at least in part on the identity assertion from the server.

18. A non-transitory computer-readable medium storing code for authenticating a user, the code comprising instructions executable to:
receive at an endpoint device login credentials for a user to gain access to the endpoint device;
receive at an endpoint agent on the endpoint device and from a browser application a request for authentication that identifies the user of the endpoint device for access to a third-party website that requires authentication of the user in an authentication format specific to the third-party website;
transmit to a server a request for an identity assertion for the user, wherein the request for the identity assertion for the user is based at least in part on the received login credentials;
receive from the server the identity assertion for the user in response to the request for the identity assertion; and
transmit to the browser application the identity assertion for asserting an identity of the user identity to the third-party website.
